(19) United States
(12) Patent Application Publication
(10) Pub. No.: US 2018/0250706 A1
(43) Pub. Date: Sep. 6, 2018

(54) BICYCLE COMPONENT, FISHING COMPONENT, METHOD OF COLORING BICYCLE COMPONENT AND METHOD OF COLORING FISHING COMPONENT

(71) Applicant: Shimano Components (Malaysia) SDN BHD., Pontian (MY)

(72) Inventors: Pui Woon Huan, Pontian (MY); Ru Miao Gan, Pontian (MY); Nuridayu Binti Shamsuddin, Pontian (MY)

(21) Appl. No.: 15/907,367

(22) Filed: Feb. 28, 2018

(30) Foreign Application Priority Data
Mar. 3, 2017 (JP) 2017-040292

(51) Int. Cl. B05D 5/06; B05D 1/18; B60B 27/02; A01K 89/00

(52) U.S. Cl. CPC B05D 5/065; B05D 1/18; A01K 97/00; A01K 89/006; B60B 27/023

(57) ABSTRACT

A bicycle component or a fishing component includes a first end portion, a second end portion and an intermediate portion extending between the first and second end portions. The first end portion has a surface on which a first dye is disposed. The second end portion has a surface which is free of the first dye or on which the first dye is disposed with a smaller amount than the first dye disposed on the surface of the first end portion. The intermediate portion includes a gradation portion having a surface on which the first dye decreases in amount from the first end portion toward the second end portion. The gradation portion has a length greater than or equal to 20 mm in a dye gradation direction extending from the first end portion toward the second end portion.

### CROSS-REFERENCE TO RELATED APPLICATIONS

This application claims priority to Japanese Patent Application No. 2017-040292, filed on Mar. 3, 2017. The entire disclosure of Japanese Patent Application No. 2017-040292 is hereby incorporated herein by reference.

### BACKGROUND

### Field of the Invention

The present invention generally relates to a bicycle component, a fishing component, a method of coloring a bicycle component, and a method of coloring a fishing component.

### Background Information

For example, a bicycle wheel rim is disclosed in U.S. Patent Application Publication No. 2008/0284238 (Patent Document 1) that can be exemplified as a decorated bicycle component. Coloring is executed for the surface of the bicycle wheel rim disclosed in Patent Document 1 such that a first color difference portion and a second color difference portion are located on the opposite sides. Additionally, Patent Document 1 discloses that the first color difference portion and the second color difference portion may be somewhat diffused regions.

### SUMMARY

In the bicycle wheel rim disclosed in Patent Document 1, the color difference portions are located on the opposite sides in the wheel rim having a ring shape, whereby aesthetics of the wheel rim are enhanced. Therefore, even when the color difference portions are diffused regions, the diffused regions are only somewhat provided and do not stand out in appearance. In view of the above, the inventor of the present invention identified, as an object, further enhancement in design of a bicycle component such as a wheel rim and a fishing component. In other words, it is an object of the present invention to provide a bicycle component having good design, a fishing component having good design, a method of coloring a bicycle component with good design, and a method of coloring a fishing component with good design.

A bicycle component in accordance with a first aspect of the present invention includes a first end portion having a surface on which a first dye is disposed, a second end portion having a surface which is free of the first dye or on which the first dye disposed with a smaller amount than the first dye disposed on the surface of the first end portion, and an intermediate portion that is extending between the first end portion and the second end portion. The intermediate portion continues to the first end portion and the second end portion. The intermediate portion includes a gradation portion having a surface on which the first dye decreases in an amount from the first end portion toward the second end portion. The gradation portion has a length greater than or equal to 20 mm in a dye gradation direction extending from the first end portion toward the second end portion.

According to the bicycle component in accordance with the first aspect of the present invention, the gradation portion is formed from the first end portion having a surface on which a first dye is disposed, toward the second end portion having a surface which is free of the first dye or on which the first dye disposed with a smaller amount than the first dye disposed on the surface of the first end portion. The gradation portion having good design has the length greater than or equal to 20 mm, and hence, can be visually confirmed in a clear manner. Therefore, the present invention can provide a bicycle component having good design.

In accordance with a second aspect of the present invention, the bicycle component according to the first aspect is configured so that the first dye is disposed on the surface of the second end portion with the smaller amount than the first dye disposed on the surface of the first end portion.

Due to this, it is possible to form a surface provided with a design that the first dye gradually decreases from the first end portion toward the second end portion. Therefore, it is possible to realize a bicycle component having better design.

In accordance with a third aspect of the present invention, the bicycle component according to the first aspect is configured so that the surface of the second end portion is free of the first dye.

Due to this, it is possible to form a surface provided with a design having definite contrast in the first dye between the first end portion and the second end portion. Therefore, it is possible to realize a bicycle component having better design.

In accordance with a fourth aspect of the present invention, the bicycle component in any one of the first to third aspects is configured so that a second dye different from the first dye is disposed on the surface of the second end portion.

Due to this, it is possible to form a surface provided with a design having two different colors. Therefore, it is possible to realize a bicycle component having better design.

In accordance with a fifth aspect of the present invention, the bicycle component according to any one of the first to fourth aspects is configured so that the gradation portion has a length greater than or equal to 30 mm in the dye gradation direction extending from the first end portion toward the second end portion.

Due to this, the gradation portion can be visually confirmed in a clearer manner. Therefore, it is possible to realize a bicycle component having better design.

In accordance with a sixth aspect of the present invention, the bicycle component according to any one of the first to fifth aspects is configured so that the gradation portion has a length less than or equal to 142 mm in the dye gradation direction extending from the first end portion toward the second end portion.

Due to this, it is possible to provide a bicycle component including a gradation portion with clearly formed start and end points.

In accordance with a seventh aspect of the present invention, the bicycle component according to any one of the first to sixth aspects is a hub body of a bicycle hub.

Due to this, the hub body of the bicycle hub is provided with the gradation portion that can be visually confirmed in a clear manner. Hence, the present invention can provide a hub body of a bicycle hub having good design.

In accordance with an eighth aspect of the present invention, the bicycle component according to the seventh aspect is configured so that the hub body includes a pair of spoke attachment flanges spaced apart from each other.

With this configuration, it is possible to provide a hub body of a bicycle hub, which is provided with a gradation portion that can be visually confirmed in a clear manner.

In accordance with a ninth aspect of the present invention, the bicycle component according to the eighth aspect is configured so that the gradation portion is located in at least part of a region between the spoke attachment flanges, and the dye gradation direction is parallel to a rotational axis of the hub body.

Due to this, the gradation portion is provided between the spoke attachment flanges. Hence, it is possible to provide a hub body of a bicycle hub, which is provided with a gradation portion that can be visually confirmed in a clearer manner.

In accordance with a tenth aspect of the present invention, the bicycle component according to any one of the first to ninth aspects is configured so that the first dye monotonically decreases in an amount on the surface from the first end portion toward the second end portion.

Due to this, the gradation portion can be effectively utilized on the entire surface of the bicycle component. Hence, it is possible to realize a bicycle component having better design.

A fishing component in accordance with an eleventh aspect of the present invention includes a first end portion having a surface on which a first dye is disposed, a second end portion having a surface which is free of the first dye or on which the first dye is disposed with a smaller amount than the first dye disposed on the surface of the first end portion, and an intermediate portion that is extending continuously between the first end portion and the second end portion. The intermediate portion continues to the first end portion and the second end portion. The intermediate portion includes a gradation portion having a surface on which the first dye decreases in an amount from the first end portion toward the second end portion. The gradation portion has a length greater than or equal to 20 mm in a dye gradation direction extending from the first end portion toward the second end portion.

According to the fishing component in accordance with the eleventh aspect of the present invention, the gradation portion is formed from the first end portion having a surface on which a first dye is disposed, toward the second end portion having a surface which is free of the first dye or on which the first dye disposed with a smaller amount than the first dye disposed on the surface of the first end portion. The gradation portion having good design has the length greater than or equal to 20 mm, and hence, can be visually confirmed in a clear manner. Therefore, the present invention can provide a fishing component having good design.

A method of coloring a bicycle component in accordance with a twelfth aspect of the present invention comprises: preparing a bicycle component including a first end portion, a second end portion and an intermediate portion that extends between the first end portion and the second end portion and that continues to the first end portion and the second end portion; and dipping the bicycle component from the first end portion into a solution containing a first dye to form a gradation portion having a surface on which the first dye decreases in an amount from the first end portion toward the second end portion in the intermediate portion by setting a dipping time of the bicycle component to be shorter for the second end portion than for the first end portion.

According to the method of coloring a bicycle component in accordance with the twelfth aspect of the present invention, the gradation portion is formed on the surface of the intermediate portion. In the gradation portion, the first dye decreases in amount from the first end portion having a surface on which a first dye is disposed, toward the second end portion having a surface which is free of the first dye or on which the first dye disposed with a smaller amount than the first dye disposed on the surface of the first end portion. Therefore, it is possible to provide a bicycle component having good design by coloring the bicycle component in the dipping step such that the gradation portion having good design has a length enough to be capable of being visually confirmed in a clear manner.

A method of coloring a fishing component in accordance with a thirteenth aspect of the present invention comprises: preparing a fishing component including a first end portion, a second end portion and an intermediate portion that extends between the first end portion and the second end portion and that continues to the first end portion and the second end portion; and dipping the fishing component from the first end portion into a solution containing a first dye to form a gradation portion having a surface on which the first dye decreases in an amount from the first end portion toward the second end portion is formed in the intermediate portion by setting a dipping time of the fishing component to be shorter for the second end portion than for the first end portion.

According to the method of coloring a fishing component in accordance with the thirteenth aspect of the present invention, the gradation portion is formed on the surface of the intermediate portion. In the gradation portion, the first dye decreases in amount from the first end portion having a surface on which a first dye is disposed, toward the second end portion having a surface which is free of the first dye or on which the first dye disposed with a smaller amount than the first dye disposed on the surface of the first end portion. Therefore, it is possible to provide a fishing component having good design by coloring the fishing component in the dipping step such that the gradation portion having good design has a length enough to be capable of being visually confirmed in a clear manner.

As explained above, the present invention can provide a bicycle component having good design, a fishing component having good design, a method of coloring a bicycle component with good design and a method of coloring a fishing component with good design.

### BRIEF DESCRIPTION OF THE DRAWINGS

Referring now to the attached drawings which form a part of this original disclosure.

FIG. 1 is a side elevational view of a bicycle including a bicycle component according to a first embodiment.

FIG. 2 is a front elevational view of a front hub including the bicycle component according to the first embodiment, with an upper half shown in cross-section.

FIG. 3 is a schematic elevational view of a hub body provided as the bicycle component according to the first embodiment.

FIG. 4 is a schematic diagram of an apparatus coloring the bicycle component according to the first embodiment.

FIG. 5 is a flowchart showing a method of coloring the bicycle component of the first embodiment.

FIG. 6 is a schematic diagram showing the respective steps (A) to (E) of the method of coloring the bicycle component of the first embodiment.

FIG. 7 is a schematic side view of a bicycle component according to a modification of the first embodiment.

FIG. 8 is a side elevational view of a fishing reel including a fishing component according to a second embodiment.

FIG. 9 is a partial side view of the fishing component according to the second embodiment.

FIG. 10 is a flowchart showing a method of coloring the fishing component according to the second embodiment.

### DETAILED DESCRIPTION OF EMBODIMENTS

Embodiments of the present invention will be hereinafter explained based on drawings. It should be noted that in the following drawings, the same or corresponding parts will be assigned with the same reference sign and the explanation thereof will not be repeated.

### First Embodiment

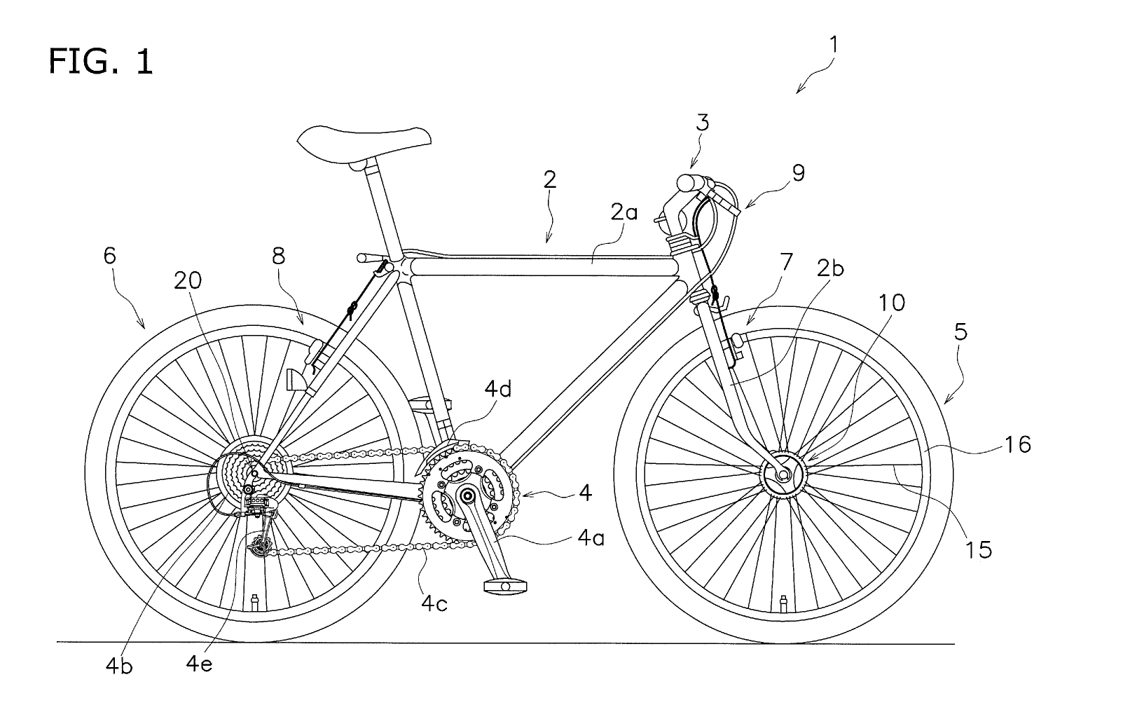

With reference to FIGS. 1 to 3, a bicycle component will be explained in accordance with a first embodiment. The bicycle component of the first embodiment is a bicycle hub body of a bicycle hub that is used in a bicycle 1 shown in FIG. 1.

First, a structure of the bicycle employing the bicycle component of the first embodiment will be explained with reference to FIG. 1. As shown in FIG. 1, the bicycle 1 of the first embodiment mainly includes a frame 2, a handlebar 3, a drive part 4, a front wheel 5, a rear wheel 6, a front brake device 7 and a rear brake device 8.

The frame 2 includes a frame body 2a and a front fork 2b. The front fork 2b is attached to a front portion of the frame body 2a so as to be rotatable about an inclined vertical axis. The handlebar 3 is fixed to the front fork 2b.

The drive part 4 includes a gear crank assembly 4a, a rear sprocket assembly 4b, a chain 4c, a front derailleur 4d, and a rear derailleur 4e. The front and rear derailleurs 4d and 4e are used for gear shifting in a conventional manner. The gear crank assembly 4a is provided on a lower portion of the frame body 2a. The gear crank assembly 4a includes right and left cranks the distal end of which pedals are attached to respectively, a crank axle coupling the right and left cranks, and a single or plurality of front sprockets. The rear sprocket assembly 4b includes a plurality of rear sprockets. The sprocket assembly 4b is attached to a rear hub of the rear wheel 6. The chain 4c is wrapped around the gear crank assembly 4a and the rear sprocket assembly 4b. The front derailleur 4d is attached to the vicinity of the single or plurality of front sprockets of the gear crank assembly 4a. The rear derailleur 4e is attached to the vicinity of the rear sprockets of the rear sprocket assembly 4b.

The front wheel 5 is attached to the distal end portion of the front fork 2b through a front hub 10. The rear wheel 6 is attached to the rear end portion of the frame body 2a through the rear hub 20.

The front and rear brake devices 7 and 8 are each actuated by operating a brake lever 9 (only one shown).

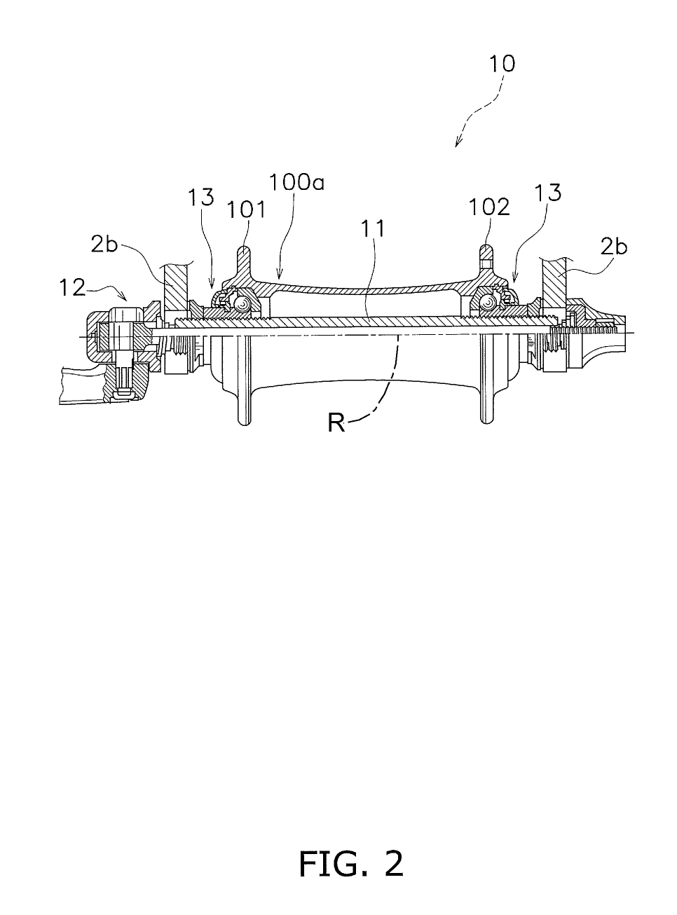

As shown in FIGS. 1 and 2, the front hub 10 is supported by the front fork 2b. As shown in FIG. 2, the front hub 10 mainly includes a hub axle 11, a hub body 100a and a pair of bearings 13.

The front hub 10 is detachably fixed to the front fork 2b through the hub axle 11 by a wheel securing device 12. The hub axle 11 defines a rotational axis R of the hub body 100a,

The hub body 100a has a tubular shape. The hub body 100a is disposed on the outer periphery of the hub axle 11. The hub body 100a is rotatably attached to the hub axle 11. Preferably, the hub body 100a includes a pair of spoke attachment flanges 101 and 102 spaced apart from each other in the axial direction. Spoke attachment holes can be directly formed on the surface of the hub body 100 without providing the hub body 100 with the spoke attachment flanges 101 and 102. As shown in FIG. 1, the pair of spoke attachment flanges 101 and 102 is coupled to a rim 16 through spokes 15.

The bearings 13 are disposed between the hub axle 11 and the hub body 100a. The bearings 13 are fixed to the inner peripheral surfaces of the both ends of the hub body 100a by press fitting. The bearings 13 are, for instance, rolling bearings.

The rear hub 20 shown in FIG. 1 has basically the same configuration as the front hub 10, but is different from the front hub 10 mainly regarding that the rear sprocket assembly 4b is attachable to the rear hub 20 and that a hub axle of the rear hub 20 is detachably fixed to the rear end portion of the frame body 2a.

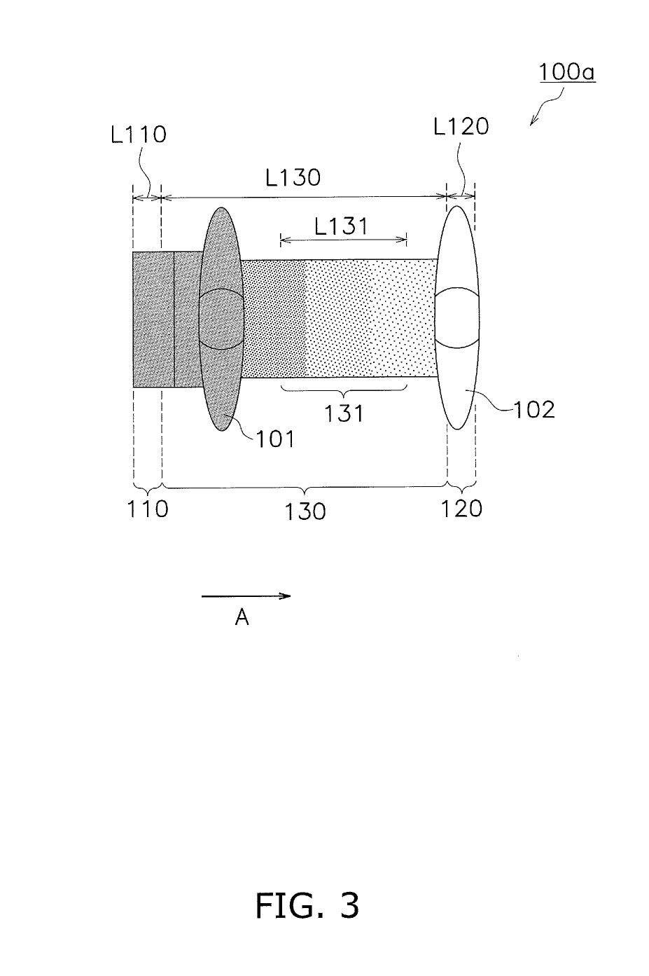

The bicycle component of the first embodiment is the hub body 100a of the front hub 10 shown in FIGS. 2 and 3. It should be noted that although the contours shown in FIGS. 2 and 3 are not matched, FIG. 3 schematically shows the hub body shown in FIG. 2 for convenience of explanation, and limitations are not imposed on the contour of the bicycle component. Additionally, FIG. 3 shows an image of the amount of a first dye on the surface with dots, and indicates that the amount of the first dye increases with increase in number of dots.

As shown in FIG. 3, the hub body 100a includes a first end portion 110 located on one end thereof (the left end in FIG. 3), a second end portion 120 located on the other end thereof (the right end in FIG. 3), and an intermediate portion 130 that extends between the first end portion 110 and the second end portion 120 and continues to the first end portion 110 and the second end portion 120.

The first end portion 110 can be only the one end, or alternatively, can have a predetermined length L110 from the one end in a direction oriented from the one end toward the other end. The predetermined length L110 is, for instance, less than or equal to 50 mm.

The second end portion 120 can be only the other end located on the opposite side of the one end, or alternatively, can have a predetermined length L120 from the other end in a direction oriented from the other end toward the one end. The predetermined length L120 is, for instance, less than or equal to 50 mm.

The first dye is disposed on the surface of the first end portion 110. The surface of the second end portion 120 is free of the first dye, or alternatively, the first dye is disposed on the surface of the second end portion 120 with a smaller amount than the first dye disposed on the surface of the first end portion 110. In other words, the first dye is visually confirmed on the first end portion 110, whereas the first dye is not visually confirmed on the second end portion 120. Alternatively, the first dye is visually confirmed on the second end portion 120 with a smaller amount than the first dye disposed on the first end portion 110. In these cases, the first dye can be disposed in the interior of the second end portion 120. In the case in which the first dye is not disposed on the surface of the second end portion 120, only a material composing the hub body 100a can be disposed on the surface of the second end portion 120. Alternatively, a second dye different from the first dye can be disposed thereon. In the case in which the first dye is disposed on the surface of the second end portion 120 with a smaller amount than the first dye disposed on the surface of the first end portion, only the first dye can be disposed on the surface of the second end portion 120, or alternatively, not only the first dye but also the second dye different from the first dye can be disposed thereon. The first and second dyes are kind of at least visually different type dyes. Preferably the first and second dyes are visually confirmed as having different colors, and for instance, are dyes having different tones of color.

Here in the present specification, the term “surface” refers a portion visually confirmed from outside, and the expression “disposed on the surface” refers that an object is disposed thereon to be visually confirmed. Therefore, even when a transparent or translucent material is disposed on a dye, for instance, the dye is visually confirmed from outside. Hence, the dye is disposed on the surface. In other words, the expression “disposed on the surface” encompasses situations that the dye is disposed on the outermost surface and that the transparent material is disposed on the dye.

Additionally, the first and second dyes are preferably colored materials, and provided for coloring an intended component. The first and second dyes are not limited to be of particular types, and for instance, can be natural dyes, synthetic dyes, fluorescent dyes or so forth.

The intermediate portion 130 includes a gradation portion 131 having a surface on which the first dye decreases in an amount from the first end portion 110 toward the second end portion 120. The gradation portion 131 is visually confirmed.

Here, the term “gradation” refers continuous change in color, and encompasses that the first dye decreases in amount from the first end portion 110 toward the second end portion 120 to the extent that the gradation portion 131 does not include a region in which the amount of the first dye is visually confirmed to be homogeneous. The region in which the amount of the first dye is visually confirmed to be homogeneous refers a region in which the amount of the first dye is homogeneous at a length of greater than or equal to 50 mm in a dye gradation direction A (a horizontal direction in FIG. 3) extending from the first end portion 110 toward the second end portion 120. Thus, in the gradation portion 131, the amount of the first dye is homogeneous at a length of less than 50 mm in the dye gradation direction A extending from the first end portion 110 toward the second end portion 120.

The gradation portion 131 preferably has a length L131 greater than or equal to 20 mm in the dye gradation direction A extending from the first end portion 110 toward the second end portion 120. Moreover, the length L131 of the gradation portion 131 is preferably greater than or equal to 30 mm in the dye gradation direction A extending from the first end portion 110 toward the second end portion 120. If the length L131 is greater than or equal to 20 mm, then the gradation portion 131 is visually confirmed in a clear manner. Hence, the gradation portion 131 having good design can be formed on the hub body 100a. If the length L131 is greater than or equal to 30 mm, then the gradation portion 131 having good design can be visually confirmed in a clearer manner. On the other hand, particular limitations are not imposed on the upper limit of the length L131 of the gradation portion 131, but in coloring a bicycle hub, the length L131 is less than or equal to 142 mm in the dye gradation direction A oriented from the first end portion 110 toward the second end portion 120.

The gradation portion 131 of the first embodiment is located on at least part of the portion between the spoke attachment flanges 101 and 102 spaced apart from each other in the dye gradation direction A extending from the first end portion 110 toward the second end portion 120. In this case, it is possible to realize the hub body 100a provided with the gradation portion 131 that can be visually confirmed in a clearer manner. It should be noted that in FIG. 3, the spoke attachment flange 101 is located on the side with the first end portion 110, whereas the spoke attachment flange 102 is located on the side with the second end portion 120.

The first dye monotonically decreases in an amount from the first end portion 110 toward the second end portion 120 on the surface of the hub body 100a in the first embodiment. Here, monotonically decreasing refers the first dye being constantly the same amount or decreases in an amount from the first end portion 110 toward the second end portion 120, and simultaneously, the first dye is smaller in an amount on the second end portion 120 than on the first end portion 110. Thus, in monotonically decreasing, the hub body 100a does not include a portion on which the first dye increases in an amount from the first end portion 110 toward the second end portion 120. Part of the hub body 100a can include a region in which the amount of the first dye is visually confirmed to be homogeneous.

As an example, the gradation portion 131 is formed between the spoke attachment flanges 101 and 102 such that the first dye is homogeneously disposed with an amount m on the surface of a predetermined region of one end (the left end in FIG. 3) included in the first end portion 110 of the hub body 100a whereas the first dye is homogeneously disposed with an amount n (m>n≥0) on the surface of a predetermined region of the other end (the right end in FIG. 3) included in the second end portion 120 of the hub body 100a. As another example, the first dye constantly decreases in an amount from the first end portion 110 toward the second end portion 120 on the surface. In other words, a gradation portion is formed over the entire range from the first end portion 110 to the second end portion 120.

If the first dye monotonically decreases in an amount on the surface from the first end portion 110 toward the second end portion 120, and simultaneously, if the first dye is disposed on the surface of the second end portion 120 with a smaller amount than the first dye disposed on the surface of the first end portion 110, then it is possible to realize a design that the first dye gradually decreases in an amount from the first end portion 110 toward the second end portion 120. If the first dye monotonically decreases in amount on the surface from the first end portion 110 toward the second end portion 120, and simultaneously, if the first dye is not disposed on the surface of the second end portion 120, then it is possible to realize a design having definite contrast in the first dye between the first end portion 110 and the second end portion 120. If the first dye monotonically decreases in an amount on the surface from the first end portion 110 toward the second end portion 120, and simultaneously, if the second dye different from the first dye is disposed on the surface of the second end portion 120, then it is possible to realize a design having two different colors.

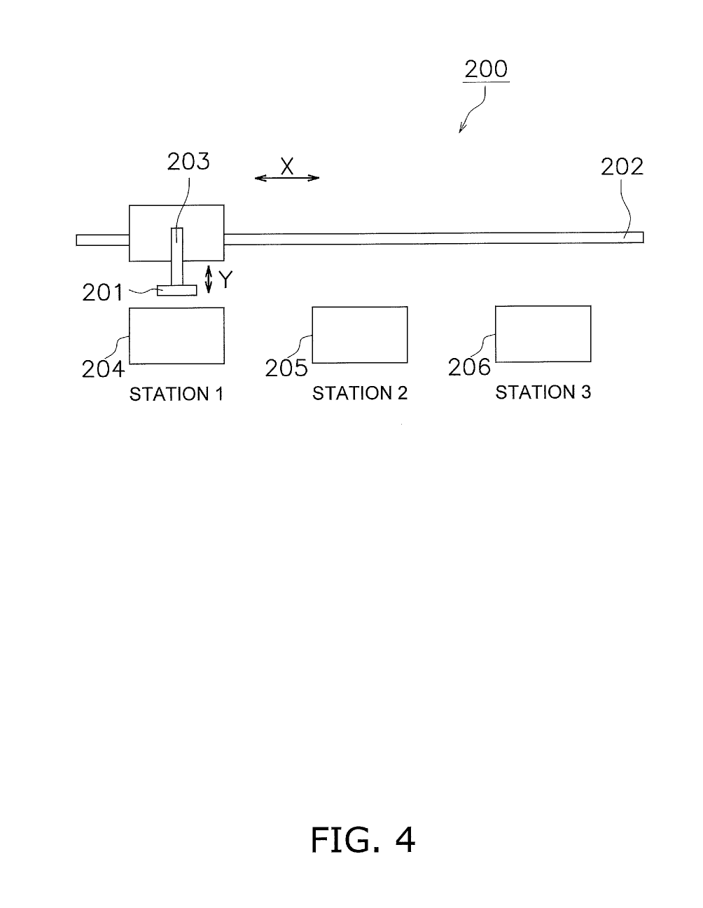

Next, a method of coloring the hub body 100a of the first embodiment will be explained with reference to FIGS. 3 to 6. In the first embodiment, the hub body 100a is colored with an apparatus 200 coloring a bicycle component as shown in FIG. 4.

With reference to FIG. 4, explanation will be provided for the apparatus 200 coloring the hub body 100a as a bicycle component of the first embodiment. As shown in FIG. 4, the coloring apparatus 200 includes a holder 201, a first axle member 202, a second axle member 203, a first cleaning part 204, a coloring part 205 and a second cleaning part 206.

The holder 201 is configured to hold a bicycle component such either the front hub 10, or the rear hub 20. The first axle member 202 moves the holder 201 in a horizontal direction X (a right-and-left direction in FIG. 4). A station 1, a station 2 and a station 3 are provided in this order from one end side (the left side in FIG. 4) to the other end side (the right side in FIG. 4) of the first axle member 202. The second axle member 203 moves the holder 201 in a vertical direction Y (an up-and-down direction in FIG. 4).

The first cleaning part 204 is located in the station 1, and includes a cleaning bath for cleaning a bicycle component, and so forth. The coloring part 205 is located in the station 2, and includes a tank that stores a solution containing a dye for coloring the bicycle component, and so forth. The second cleaning part 206 is located in the station 3, and includes a cleaning bath for cleaning the bicycle component, and so forth.

It should be noted that, in the coloring part 205, the dye-contained solution stored in the tank is, for instance, a solution obtained by dissolving a dye in a solvent such as water.

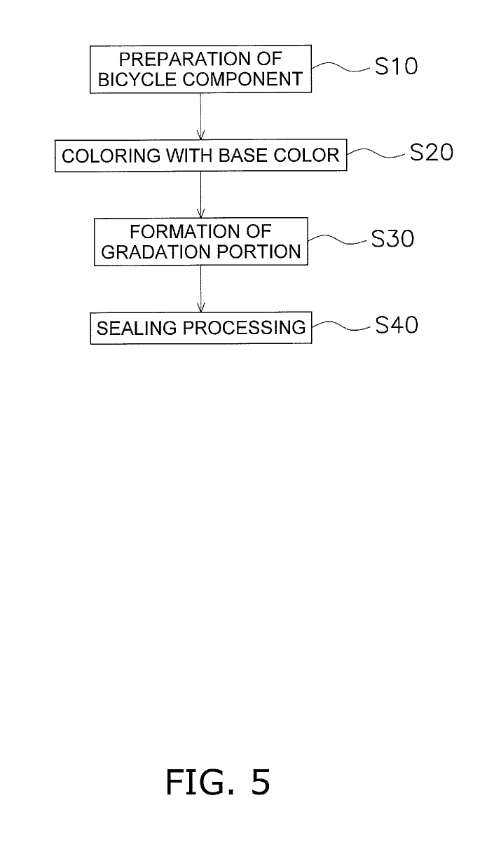

First, as shown in FIG. 5, a bicycle component is prepared (step S10). The bicycle component includes the first end portion 110, the second end portion 120 and the intermediate portion 130 that extends between the first end portion 110 and the second end portion 120 and continues to the first end portion 110 and the second end portion 120. In the first embodiment, a pre-processed hub body is prepared as the bicycle component. For example, this step (S10) will be executed as follows.

The holder 201 is located in the station 1 by the first axle member 202, and the hub body made of aluminum is held by the holder 201. The holder 201 is lowered by the second axle member 203, whereby the hub body is moved to the first cleaning part 204. Then, cleaning processing is executed for the hub body. After cleaned, the hub body is taken out of the holder 201, and alumite (anodic oxidation) treatment is executed for the hub body, whereby a coating including recesses on the surface thereof is formed on the hub body. It should be noted that a polishing step, a smut removing step and so forth can be further executed for the hub body on an as-needed basis. The hub body prepared as described above is held by the holder 201 located in the station 1.

Next, the surface of the hub body is colored with a base color (step S20). Particular limitations are not imposed on the base color. The base color can be the same as the color of the first dye composing the gradation portion, or alternatively, can be the color of the second dye different from the first dye. For example, this step (S20) will be executed as follows.

The holder 201, holding the hub body, is moved to the station 2 by the first axle member 202. In the station 2, a tank, which stores a solution containing a dye composing the base color, is prepared as the coloring part 205. The holder 201 holding the hub body is lowered by the second axle member 203, whereby the hub body is dipped into the solution containing the dye. Particular limitations are not imposed on the dye gradation direction and the speed to dip the hub body. Dipping of the hub body is executed such that a homogeneous amount of the dye composing the base color is disposed on the entire surface of the hub body. In other words, the hub body is colored with the base color such that the dye is visually confirmed as being homogeneous without forming any gradation on the entire surface of the hub body. Particular limitations are not imposed on the dipping time. However, the density of the base color is adjustable by adjusting the dipping time. After elapse of a predetermined dipping time, the second axle member 203 is elevated, whereby the hub body is taken out of the solution. Thus, the hub body is finished being colored with the base color. Through executing this step (S20), the dye composing the base color is disposed in the recesses of the coating. It should be noted that this step (S20) can be omitted.

Thereafter, the holder 201 holding the hub body to which the base color is attached, is moved to the station 1 or 3 by the first axle member 202. The holder 201 is lowered by the second axle member 203, and the hub body is cleaned. Then, the holder 201 is elevated by the second axle member 203, and the holder 201 holding the cleaned hub body, is moved to the station 2 by the first axle member 202.

Next, the bicycle component is dipped from the first end portion 110 into the solution containing the first dye so as to form a gradation portion (step S30). In this step (S30), the gradation portion 131 having a surface on which the first dye decreases in amount from the first end portion 110 toward the second end portion 120, is formed in the intermediate portion 130 by setting the dipping time of the intermediate portion 130 to be shorter for the second end portion 120 than for the first end portion 110. In this step (S30), the gradation portion 131 is formed by controlling the speed and the distance to dip the hub body into the solution containing the first dye. Specifically, this will be executed as follows.

In the station 2, a tank which stores the solution containing the first dye, is prepared as the coloring part 205. If the base color and the color composing the gradation portion are the same, the tank used in the step (S20) of coloring the hub body with the base color can be herein used again, or alternatively, another tank can be herein prepared. If another tank is herein prepared, the density of the first dye in the solution can be the same as or different from that in the aforementioned tank. The temperature of the solution containing the first dye is, for instance, 40 to 60 degrees Celsius.

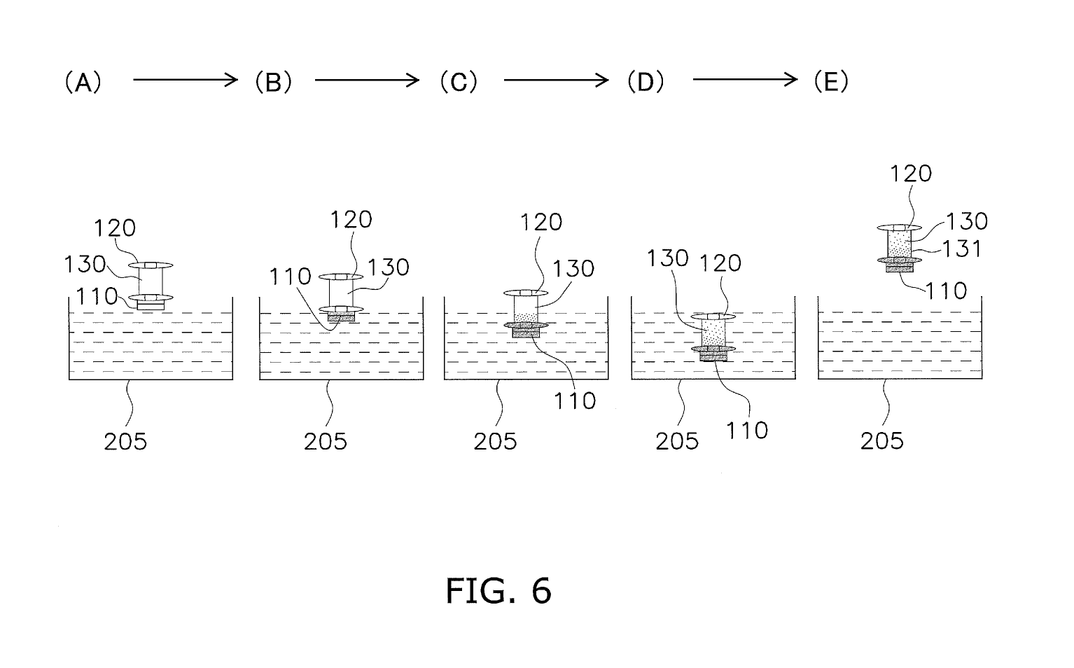

As shown in step (A) of FIG. 6, the hub body is held by the holder 201 such that the first end portion 110 is located down while the second end portion 120 is located up. In this condition, as shown in step (B) of FIG. 6, the hub body is dipped from the first end portion 110 into the solution containing the first dye. Subsequently, as shown in step (C) of FIG. 6, the intermediate portion 130 continuing to the first end portion 110 is further dipped into the solution. At this time, the speed and the distance to dip the hub body into the solution are controlled by controlling the speed and the distance to move the holder 201 in the vertical direction Y by the second axle member 203. In detail, a large amount of the first dye is attached to the vicinity of the first end portion 110 by dipping the hub body into the solution at a low speed at an early stage. A control to increase the dipping speed is executed when it is determined that a position on the intermediate portion 130 corresponding to a starting point of the gradation portion, is dipped into the solution. Accordingly, the first dye to be attached to the surface of the intermediate portion 130 decreases in amount from the first end portion 110 toward the second end portion 120. It should be noted that as a method of increasing the speed, the speed can be increased constantly, for instance, intermittently every predetermined distance of movement, from the first end portion 110 toward the second end portion 120.

Then, as shown in step (D) of FIG. 6, the second end portion 120 is dipped into the solution. The amount of the first dye to be attached to the vicinity of the second end portion 120 is lessened or almost eliminated by further shortening the dipping time on the side with the second end portion 120. Next, as shown in step (E) of FIG. 6, the entirely dipped hub body is moved upward at a high speed, and is taken out of the solution.

It should be noted that instead of dipping the entire hub body into the solution as shown in step (D) of FIG. 6, only the first end portion 110 and the intermediate portion 130 can be dipped into the solution without dipping the second end portion 120 thereinto. Additionally, without dipping a region of the intermediate portion 130, located on the side with the second end portion 120, and without dipping the second end portion 120 into the solution, only the rest of the intermediate portion 130, located on the first end portion 110 side, and the first end portion 110 can be dipped into the solution.

With the step (S30) of forming gradation being executed, the first dye is disposed on the dye composing the base color within the recesses of the coating.

Thus, in this step (S30), the dipping speed is set to be relatively low for the side with the first end portion 110 on which a large amount of the first dye is supposed to be disposed, whereby a large amount of the first dye is attached to the first end portion 110 side; and simultaneously, the dipping speed is set to be relatively high for the side with the second end portion 120 on which a small amount of the first dye is supposed to be disposed, whereby a small amount of the first dye is attached to the second end portion 120 side. Then, the entirety or the approximate entirety of the hub body (the entirety or part of the first end portion 110 and the intermediate portion 130) is dipped into the solution. Thereafter, the hub body is pulled out of the solution at a high speed. With this control, it is possible to form the gradation portion 131, and besides, realize the hub body on the surface of which the first dye monotonically decreases in amount from the first end portion 110 toward the second end portion 120. Thus, in the step (S30) of forming the gradation portion in the first embodiment, the processing of reducing the color of the first dye is executed for at least part of the surface of the hub body by dipping the hub body into the solution containing the first dye through the control of speed and distance parameters.

It should be noted that when coloring is executed with the second dye different from the first dye in the step (S20) of coloring with the base color and the first dye is not disposed on the second end portion 120 in the step (S30) of forming gradation, the second dye composing the base color is disposed on the surface of the second end portion 120.

Next, the holder 201, holding the hub body on which the gradation portion 131 is formed, is moved to the station 3 by the first axle member 202. The holder 201 is lowered by the second axle member 203, and the hub body is cleaned. Accordingly, an excess amount of the first dye attached to the surface and so forth are removed from the surface.

Next, the cleaned hub body is detached from the holder 201, and a sealing processing is executed for the hub body (step S40). A sealing time is, for instance, 5 to 15 minutes, and a sealing temperature is, for instance, 85 to 95 degrees Celsius. With this step (S40) being executed, a hydrate film is formed in the coating recesses into which the dye has been intruded. Hence, the dye is sealed in the recesses, and is also visually confirmed in appearance.

With the aforementioned steps (S10 to S40) being executed, the hub body as the bicycle component can be colored. Therefore, the hub body 100a including the gradation portion 131 shown in FIG. 3 can be manufactured.

In consecutively coloring a plurality of hub bodies, the aforementioned steps (S10 to S40) are repeated. Specifically, the holder 201 is located in the station 3, and a hub body to be colored is held by the holder 201. The holder 201 is moved to the station 2 by the first axle member 202; the hub body is colored with the base color on an as-needed basis (step S20); and the gradation portion is formed on the hub body (step S30). The holder 201 is moved to the station 1 by the first axle member 202; the hub body is cleaned; the hub body is detached from the holder 201; and the sealing processing is executed for the hub body (step S40).

Moreover, a hub body to be colored next is held by the holder 201 in the station 1. The holder 201 is moved to the station 2 by the first axle member 202; the next hub body is colored with the base color on an as-needed basis (step S20); and the gradation portion is formed on the next hub body (step S30). The holder 201 is moved to the station 3 by the first axle member 202; the next hub body is cleaned; the next hub body is detached from the holder 201; and the sealing processing is executed for the next hub body (step S40).

Thus, with use of the coloring apparatus 200 shown in FIG. 4, a plurality of bicycle components can be consecutively colored. Hence, this is industrially advantageous. It should be noted that the coloring apparatus 200 in the present embodiment is exemplary only, and particular limitations are not imposed on the apparatus for executing the coloring method.

It should be noted that in the present embodiment, the bicycle component can be dipped into the solution containing the dye while part of the surface thereof is covered with a masking material in the step (S20) of coloring with the base color and/or the step (S30) of forming the gradation portion. The dye is not disposed on the region covered with the masking material.

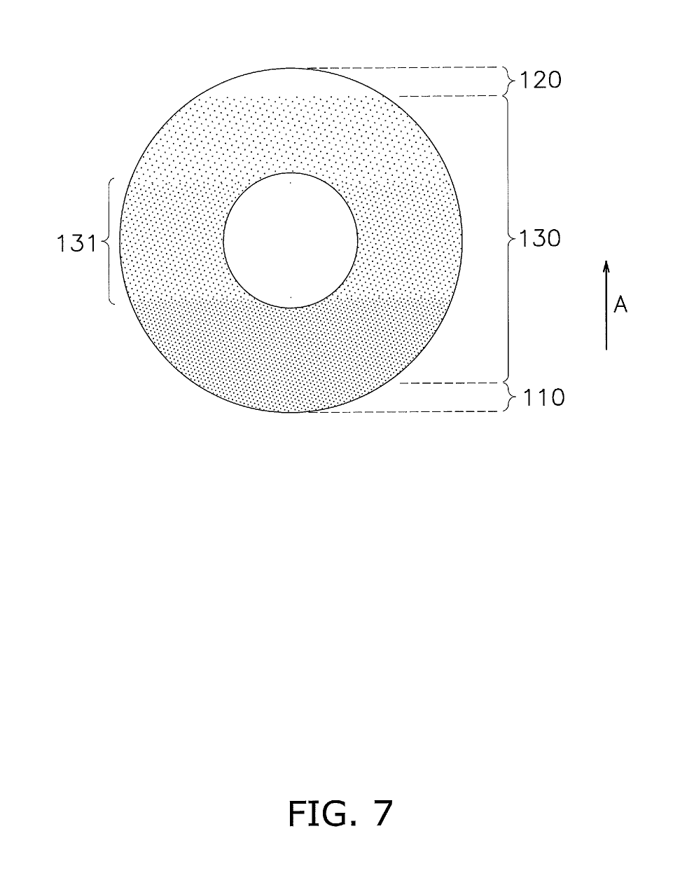

The present embodiment has been herein explained by exemplifying the hub body as the bicycle component. However, the bicycle component of the present invention is not limited to the hub body, and the present invention is applicable to general components composing a bicycle. Therefore, limitations are not imposed on the shape of the bicycle component of the present invention, and the present invention is applicable to a member having an arbitrary shape. The bicycle component includes the first and second end portions 110 and 120, which are disposed on the opposite sides in the predetermined (dye gradation) direction A, and the intermediate portion 130 located therebetween. Hence, when the bicycle component is a ring-shaped member, for instance, a rim of a bicycle wheel or so forth, the first and second end portions 110 and 120 are located as shown in FIG. 7. It should be noted that other than the bicycle hub, bicycle components to which the present invention is applicable include, for instance, a sprocket, a crank arm, a bottom bracket assembly, a pedal, a brake device, a transmission, a brake operating device, a gear shift operating device, a disc brake caliper, a disc brake rotor, a rim, a spoke, a suspension, a seat post, an assist bicycle drive unit, a stem, a handle, a front fork, a frame and so forth.

Additionally, the gradation portion 131 can be formed in an arbitrary position on a bicycle component. Hence, depending on the shape of the bicycle component, the gradation portion 131 can be formed on a region of the bicycle component that is judged to enhance the design of the bicycle component.

Additionally, the present embodiment has been explained by exemplifying the hub body made of aluminum. However, the bicycle component of the present invention is not limited to the one made of aluminum, and can employ the one made of an arbitrary material.

### Second Embodiment

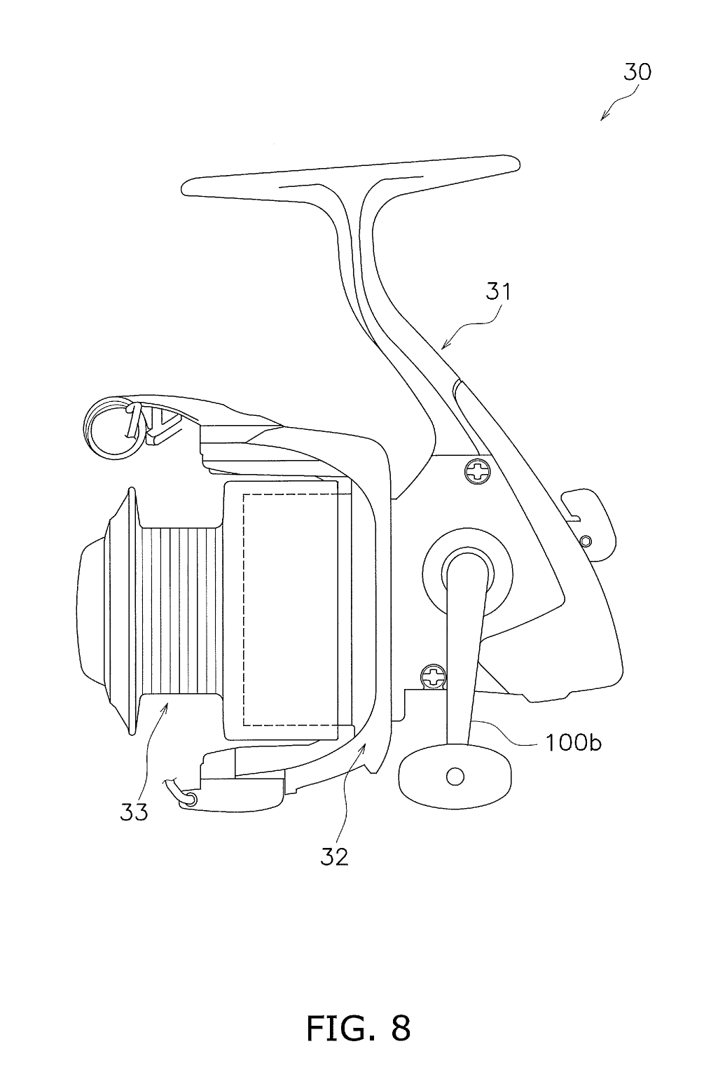

The bicycle component has been explained in the first embodiment, whereas a fishing component including the gradation portion of the first embodiment will be explained in the present embodiment. The fishing component, which is an embodiment of the present invention, will be explained with reference to FIG. 8. The fishing component of the second embodiment is a handle of a reel shown in FIG. 8.

First, the structure of the reel employing the fishing component of the embodiment 2 will be explained with reference to FIG. 8. As shown in FIG. 8, a reel 30 of the embodiment 2 is a spinning reel, and mainly includes a handle 100b, a reel body 31, a rotor 32 and a spool 33.

The reel body 31 is attachable to a fishing rod, and the handle 100b is attached thereto so as to be rotatable about a right-and-left axis. The rotor 32 is rotated in conjunction with the rotation of the handle 100b and leads a fishing line to the spool 33. The rotor 32 is supported at the front portion of the reel body 31 so as to be rotatable about a back-and-forth axis. The spool 33 winds up the fishing line, led by the rotor 32, onto the outer peripheral surface thereof. The spool 33 is disposed at the front portion of the rotor 32 so as to be capable of reciprocating in a back-and-forth axial direction.

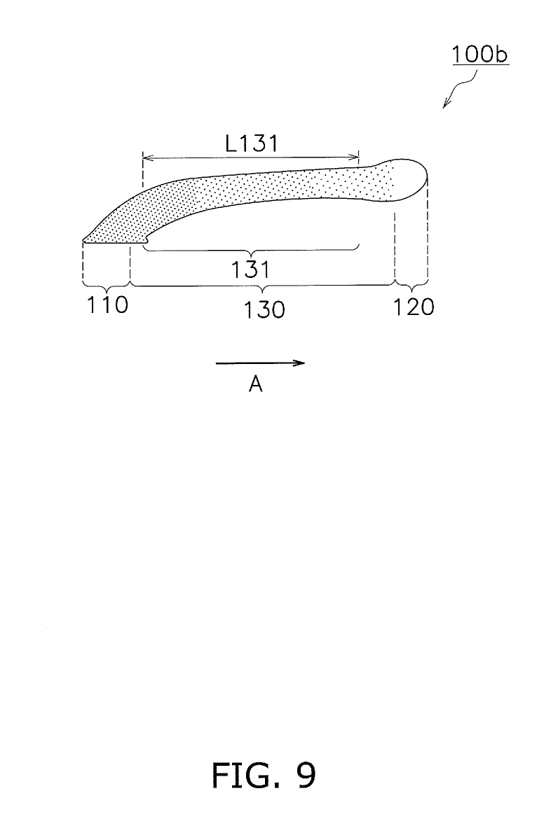

The fishing component according to the present embodiment is the handle 100b shown in FIGS. 8 and 9. It should be noted that although the contours shown in FIGS. 8 and 9 are not matched, FIG. 9 schematically shows the handle shown in FIG. 8 for convenience of explanation, and limitations are not imposed on the contour of the fishing component of the present invention. Additionally, FIG. 9 shows an image of the amount of the first dye on the surface with dots.

The handle 100b of the second embodiment is different in shape from the hub body 100a of the first embodiment, but is common to the hub body 100a in that each of the handle 100b and the hub body 100a includes the gradation portion 131.

In short, as shown in FIG. 9, the handle 100b includes the first end portion 110 located on one end (the left end in FIG. 9), the second end portion 120 located on the other end (the right end in FIG. 9), and the intermediate portion 130 that extends between the first end portion 110 and the second end portion 120 and continues to the first end portion 110 and the second end portion 120.

The first dye is disposed on the surface of the first end portion 110. The first dye is not disposed on the surface of the second end portion 120. Alternatively, the first dye is disposed on the surface of the second end portion 120 with a smaller amount than the first dye disposed on the surface of the first end portion 110. If the first dye is not disposed on the surface of the second end portion 120, then only a material composing the handle 100b can be disposed on the surface of the second end portion 120, or alternatively, the second dye different from the first dye can be disposed thereon. If the first dye is disposed on the surface of the second end portion 120 with a smaller amount than the first dye disposed on the surface of the first end portion, only the first dye can be disposed on the surface of the second end portion 120, or alternatively, not only the first dye but also the second dye different from the first dye can be disposed thereon.

The intermediate portion 130 includes the gradation portion 131 having a surface on which the first dye decreases in an amount from the first end portion 110 to the second end portion 120. The length L131 of the gradation portion 131 is greater than or equal to 20 mm, and is preferably greater than or equal to 30 mm, in the dye gradation direction A extending from the first end portion 110 toward the second end portion 120. Particular limitations are not imposed on the upper limit of the length L131 of the gradation portion 131, but from the perspective of enabling easy coloring, the length L131 is less than or equal to 100 mm in the dye gradation direction A oriented from the first end portion 110 toward the second end portion 120.

The first dye monotonically decreases in amount from the first end portion 110 toward the second end portion 120 on the surface of the handle 100b in the present embodiment.

Additionally, a method of coloring the handle 100b as the fishing component of the present embodiment is different from the method of the first embodiment in that an object to be colored is the handle as a reel component. Therefore, the method is executed with the coloring apparatus 200 shown in FIG. 4, which is the same as that used in the embodiment 1, for coloring the fishing component of the second embodiment.

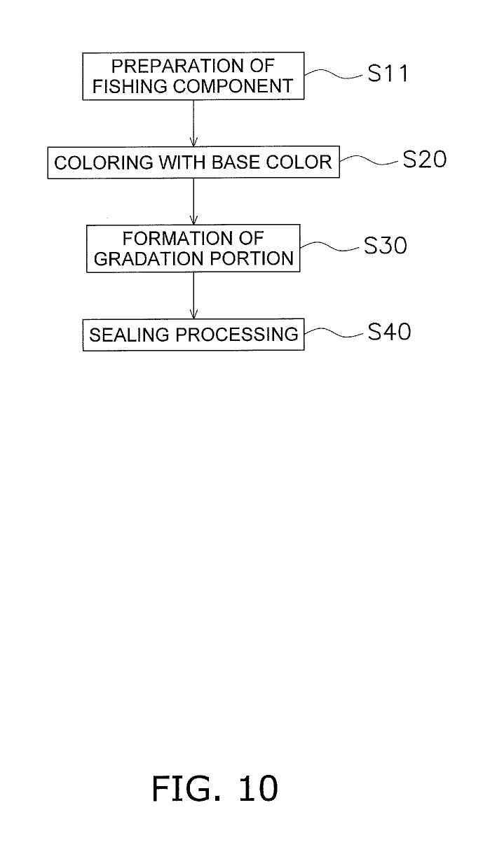

In short, firstly as shown in FIG. 10, a fishing component (a handle in the second embodiment) is prepared (step S11). The fishing component includes the first end portion 110, the second end portion 120, and the intermediate portion 130 that extends between the first end portion 110 and the second end portion 120 and continues to the first end portion 110 and the second end portion 120. Next, the fishing component is colored with a base color on an as-needed basis (step S20). Next, the fishing component (the handle in the present embodiment) is dipped from the first end portion 110 into a solution containing the first dye (step S30). In the dipping step (S30), the gradation portion 131 having a surface on which the first dye decreases in amount from the first end portion 110 to the second end portion 120, is formed in the intermediate portion 130 by setting the dipping time of the intermediate portion 130 to be shorter for the second end portion 120 side than for the first end portion 110 side. Next, a sealing processing is executed for the fishing component on an as-needed basis (step S40).

The second embodiment has been herein explained by exemplifying the handle of the reel as the fishing component. However, the fishing component of the present invention is not limited to the handle, and the present invention is applicable to general components composing the reel. Additionally, the fishing component of the present invention is not limited to a component composing the reel. For example, the present invention is also applicable to a component composing a fishing rod.

The embodiments of the present invention have been explained as described above. However, it has also been initially planned to suitably combine the features of the respective embodiments. Additionally, it should be understood that the embodiments disclosed herein are exemplary only and not restrictive in all aspects. The scope of the present invention is indicated by the appended claims rather than by the aforementioned embodiments, and all the changes that come within the meaning and range equivalent to the claims are intended to be embraced therein.

What is claimed is:

1. A bicycle component comprising:
a first end portion having a surface on which a first dye is disposed;
a second end portion having a surface which is free of the first dye or on which the first dye is disposed with a smaller amount than the first dye disposed on the surface of the first end portion; and
an intermediate portion extending between the first end portion and the second end portion, the intermediate portion continuing to the first end portion and the second end portion,
the intermediate portion including a gradation portion having a surface on which the first dye decreases in an amount from the first end portion toward the second end portion, and
the gradation portion having a length greater than or equal to 20 mm in a dye gradation direction extending from the first end portion toward the second end portion.

2. The bicycle component according to claim 1, wherein
the first dye is disposed on the surface of the second end portion with the smaller amount than the first dye disposed on the surface of the first end portion.

3. The bicycle component according to claim 1, wherein
the surface of the second end portion is free of the first dye.

4. The bicycle component according to claim 1, wherein
a second dye different from the first dye is disposed on the surface of the second end portion.

5. The bicycle component according to claim 1, wherein
the gradation portion has a length greater than or equal to 30 mm in the dye gradation direction extending from the first end portion toward the second end portion.

6. The bicycle component according to claim 1, wherein
the gradation portion has a length less than or equal to 142 mm in the dye gradation direction extending from the first end portion toward the second end portion.

7. The bicycle component according to claim 1, wherein
the bicycle component is a hub body of a bicycle hub.

8. The bicycle component according to claim 7, wherein
the hub body includes a pair of spoke attachment flanges spaced apart from each other.

9. The bicycle component according to claim 8, wherein
the gradation portion is located in at least part of a region between the spoke attachment flanges, and the dye gradation direction is parallel to a rotational axis of the hub body.

10. The bicycle component according to claim 1, wherein
the first dye monotonically decreases in an amount on the surface from the first end portion toward the second end portion.

11. A fishing component comprising:
a first end portion having a surface on which a first dye is disposed;
a second end portion having a surface which is free of the first dye or on which the first dye is disposed with a smaller amount than the first dye disposed on the surface of the first end portion; and
an intermediate portion extending between the first end portion and the second end portion, the intermediate portion continuing to the first end portion and the second end portion,
the intermediate portion including a gradation portion having a surface on which the first dye decreases in an amount from the first end portion toward the second end portion, and
the gradation portion having a length greater than or equal to 20 mm in a dye gradation direction extending from the first end portion toward the second end portion.

12. A method of coloring a bicycle component comprising:
preparing a bicycle component including a first end portion, a second end portion and an intermediate portion, the intermediate portion being extending between the first end portion and the second end portion, the intermediate portion continuing to the first end portion and the second end portion; and
dipping the bicycle component from the first end portion into a solution containing a first dye to form a gradation portion having a surface on which the first dye decreases in an amount from the first end portion toward the second end portion in the intermediate portion by setting a dipping time of the bicycle component to be shorter for the second end portion than for the first end portion.

13. A method of coloring a fishing component comprising:
preparing a fishing component including a first end portion, a second end portion and an intermediate portion, the intermediate portion being extending between the first end portion and the second end portion, the intermediate portion continuing to the first end portion and the second end portion, and
dipping the fishing component from the first end portion into a solution containing a first dye to form a gradation portion having a surface on which the first dye decreases in amount from the first end portion toward the second end portion in the intermediate portion by setting a dipping time of the fishing component to be shorter for the second end portion than for the first end portion.
